(19) United States
(12) Patent Application Publication
(10) Pub. No.: US 2021/0157707 A1
(43) Pub. Date: May 27, 2021

(54) TRANSFERABILITY DETERMINATION APPARATUS, TRANSFERABILITY DETERMINATION METHOD, AND RECORDING MEDIUM

(71) Applicant: Hitachi, Ltd., Tokyo (JP)

(72) Inventors: Takuya KOMATSUDA, Tokyo (JP); Takuya ODA, Tokyo (JP)

(21) Appl. No.: 17/012,395

(22) Filed: Sep. 4, 2020

(30) Foreign Application Priority Data
Nov. 26, 2019 (JP) 2019-212832

(51) Int. Cl. G06F 11/34; G06F 11/30; G06F 11/32

(52) U.S. Cl. CPC G06F 11/3447; G06F 11/328; G06F 11/3086

(57) ABSTRACT

The transferability determination apparatus includes: a data input unit which receives the input of first static feature data and first observation data related to a transfer source task; a static feature information modeling unit configured to generate a static feature model using the first static feature data as an objective variable and the feature values related to the first observation data as an explanatory variable; a transfer source data selecting unit configured to receive second static feature data of the transfer destination task and select first static feature data; a data extension unit configured to receive second observation data of the transfer destination task and calculate extended observation data on the basis of the second observation data and the static feature model; and a transfer source model evaluation unit configured to calculate a generalization error of a prediction result obtained by inputting the extended observation data to the analysis model.

### CROSS-REFERENCE TO PRIOR APPLICATION

This application relates to and claims the benefit of priority from Japanese Patent Application No. 2019-212832 filed on Nov. 26, 2019, the entire disclosure of which is incorporated herein by reference.

### BACKGROUND

The present invention relates to a technique of determining whether an analysis model constructed for a certain task can be transferred to an analysis model for another task.

With the improvement of sensing techniques, the number of cases in which data is utilized to obtain a management effect has increased. In particular, there is a high demand for detecting the signs of facility failures and detecting defective products in the manufacturing industry, which is performed in many factories.

In the analysis of sensor data for detecting defective products, first, sensor data related to the temperature and air volume collected from facilities during manufacturing is collected, a feature value based on a statistic amount such as a mean or a variance of the sensor data is calculated, and an analysis model (referred to as an analysis model or simply a model) for identifying a changing point of the feature value before and after occurrence of defects is constructed. In this way, it is possible to automatically detect occurrence of defects using the analysis model.

On the other hand, in recent years, there is a demand for manufacturing a small quantity of products of various types due to diversification of customer's needs. With the change in product type to be manufactured, the person in charge of a manufacturing site needs to change manufacturing parameters such as temperature and air volume, and the tendency of change in sensor data changes when the manufacturing parameters change. Therefore, it is necessary to construct analysis models for respective product types, and construction of analysis models for all product types incurs a large amount of man-hour. From such a background, it is requested to reduce the amount of man-hour of model construction.

In order to reduce the amount of man-hour of model construction, there has been an approach to transfer an analysis model or data related to product types analyzed in the past to construction of an analysis model of a new analysis target product type. However, when the transfer source data or analysis model is not suitable for a transfer destination analysis model, negative transfer may occur. Here, negative transfer refers to a phenomenon in which, since the transfer source data or analysis model is not similar to that of the transfer destination, the result of application of transfer training leads to decrease in the performance of a transfer destination model. Therefore, it is requested to determine whether transfer source data is effective in improving the performance of a transfer destination model.

For example, Japanese Patent Application Publication No. 2016-191975 discloses a technique capable of determining whether an advance domain is effective in transfer training with high accuracy. A machine learning apparatus disclosed in Japanese Patent Application Publication No. 2016-191975 includes: an acquisition unit that acquires target domain including a plurality of pieces of training data each having a detection target feature under prescribed conditions and an advance domain including training candidate data having a detection target feature under conditions different from the prescribed conditions; a trial transfer training unit that executes machine learning in which transfer training is introduced using the target domain and the advance domain acquired by the acquisition unit to generate a decision tree used for detecting the detection target; and a determining unit that determines whether the advance domain acquired by the acquisition unit is effective for transfer training using all leaf nodes of the decision tree generated by the trial transfer training unit.

### SUMMARY

In the technique disclosed in Japanese Patent Application Publication No. 2016-191975, when the feature of the transfer source data is not similar to that of the transfer destination data, it is not possible to extract data effective for transfer training and to apply transfer training. In the technique disclosed in Japanese Patent Application Publication No. 2016-191975, when there are a number of candidates for transfer source data, it incurs man-hour for selecting data to be used from the transfer source data.

The present invention has been made in view of the problems, and an object thereof is to provide a technique capable of reducing the amount of man-hour required for selecting data to be used for a transfer destination model among a plurality of pieces of transfer source data and appropriately determining whether a transfer source model can be transferred as a transfer destination model.

In order to attain the object, a transferability determination apparatus according to a first aspect is a transferability determination apparatus that determines transferability of an analysis model of a transfer source task to a transfer destination task, including: a data input unit configured to receive the input of first static feature data indicating static features related to a target object and/or an event of the transfer source task and first observation data obtained by observing an object and/or an event that affects the target object and/or the event of the transfer source task; a static feature information modeling unit configured to generate a static feature model using the first static feature data as an objective variable and the feature value related to the first observation data as an explanatory variable; a transfer source data selecting unit configured to receive second static feature data indicating static features related to a target object and/or an event of the transfer destination task and select first static feature data to be used for processing among a plurality of pieces of first static feature data on the basis of a distance between the first static feature data and the second static feature data; a data extension unit configured to receive second observation data obtained by observing an object and/or an event that affects the target object and/or the event of the transfer destination task and calculate extended observation data appropriate for use in the analysis model on the basis of the second observation data, the selected first static feature data, and the static feature model; and a transfer source model evaluation unit configured to calculate a generalization error of a prediction result obtained by inputting the extended observation data to the analysis model and evaluate transferability of the analysis model to the transfer destination task on the basis of the generalization error.

According to the present invention, it is possible to reduce the amount of man-hour required for selecting data to be used for a transfer destination model among a plurality of pieces of transfer source data and appropriately determine whether a transfer source model can be transferred as a transfer destination model.

### BRIEF DESCRIPTION OF THE DRAWINGS

FIG. 1 is a block diagram illustrating an example of a configuration of an analysis model transferability determination apparatus according to an embodiment;

FIG. 2 is a schematic block diagram of the analysis model transferability determination apparatus according to the embodiment;

FIG. 3 is a diagram illustrating a configuration example of a static feature data table;

FIG. 4 is a diagram illustrating a configuration example of an observation data table;

FIG. 5 is a diagram illustrating a configuration example of an analysis model table;

FIG. 6 is a diagram illustrating a configuration example of a static feature model table;

FIG. 7 is a diagram illustrating a configuration example of an extended data table;

FIG. 8 is a diagram illustrating a configuration example of a model transferability table;

FIG. 9 is a diagram illustrating an example of a feature value generation file;

FIG. 10 is a flowchart illustrating an example of a main process of the analysis model transferability determination apparatus according to the embodiment;

FIG. 11 is a flowchart illustrating an example of a static feature information modeling process according to the embodiment;

FIG. 12 is a flowchart illustrating an example of a transfer source data selection process according to the embodiment;

FIG. 13 is a flowchart illustrating an example of a transfer destination data extension process according to the embodiment;

FIG. 14 is a flowchart illustrating an example of a performance evaluation process according to the embodiment;

FIG. 15 is a diagram illustrating an example of a data input screen;

FIG. 16 is a diagram illustrating an example of an analysis model information input screen; and

FIG. 17 is a diagram illustrating an example of a transferability determination result screen.

### DETAILED DESCRIPTION OF THE EMBODIMENT

Hereinafter, an embodiment will be described with reference to the drawings. The embodiment described below are not intended to limit the inventions according to the claims, and all elements and combinations thereof described in the embodiments are not necessarily essential to the solving means for the invention.

In the following description, although information is sometimes described using expressions of an “AAA table” and an “AAA file”, the information may be expressed by an arbitrary data structure. That is, the “AAA table” and the “AAA file” may be referred to as “AAA information” in order to show that information does not depend on a data structure.

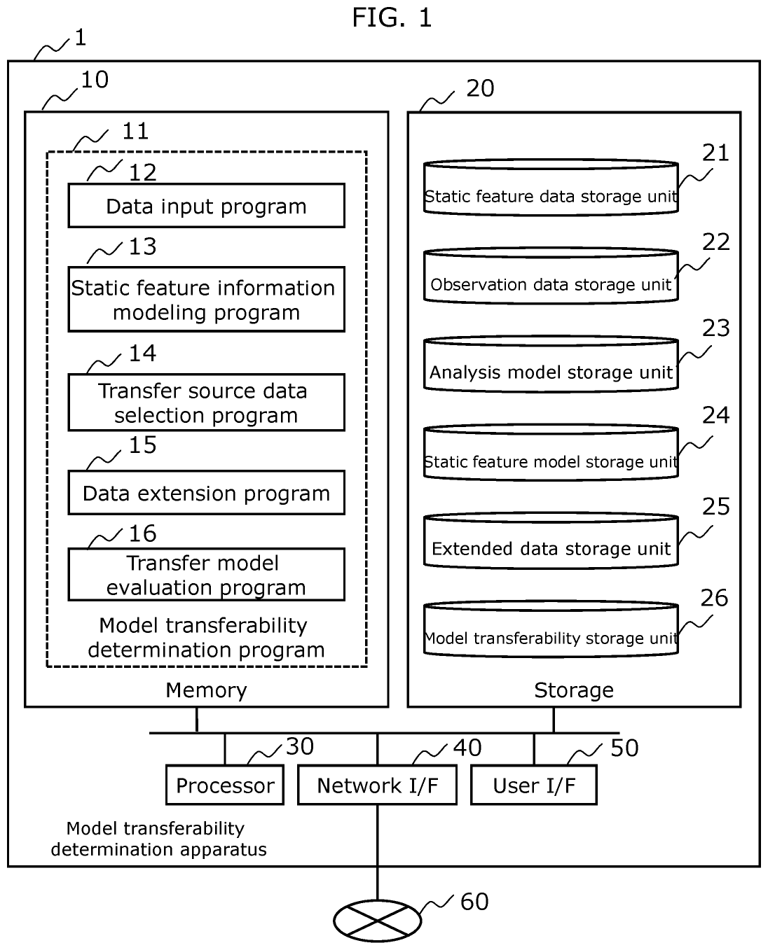

FIG. 1 is a block diagram illustrating an example of a configuration of an analysis model transferability determination apparatus according to an embodiment.

An analysis model transferability determination apparatus 1 as an example of a transferability determination apparatus is an apparatus for determining whether an analysis model (a transfer source model) generated on the basis of observation data obtained from an observation target object or event as a behavior thereof in order to solve a certain task can be transferred to a certain task (a transfer destination task) (that is, determining transferability) and presenting a determination result thereof.

Here, a task is a problem to be solved in a target operation and is the detection of defects in a certain product or the sign of failures in a certain manufacturing facility, for example. The analysis model is a model used for executing a task. For example, when an observation target is a product and a task for a product is executed, the analysis model receives, as its input, numerical data observed by sensors and collected for observing an observation target product and/or a feature value related to the numerical data and outputs a probability that the product is defective or a determination result as to whether the product is defective. The feature value related to numerical data indicates data obtained by processing the numerical data. The analysis model related to the observation target is given from a user, for example.

According to the analysis model transferability determination apparatus 1, it is possible to transfer an analysis model (a transfer source model) generated for determining a failure in a target product as an analysis model (a transfer destination model) for determining a failure in another product and to solve defect determination (another task) of another product with a small amount of man-hour.

The analysis model transferability determination apparatus 1 is configured as a computer such as a PC (Personal Computer), for example, and includes a memory 10, a storage 20, a processor 30, a network interface (I/F) 40, and a user interface (I/F) 50.

The network I/F 40 is an interface such as a cable LAN card or a wireless LAN card, for example, and communicates with another apparatus via a network such as a WAN (Wide Area Network) 60. The network I/F 40 may be coupled to a LAN (Local Area Network) or any other network.

The user I/F 50 is an input device such as a keyboard or a mouse and an output device such as a display and receives the input from a user and outputs (presents) various pieces of information to a user.

The processor 30 executes various types of process by executing programs stored in the memory 10. For example, the processor 30 executes programs of the memory 10 according to the data or the like input from the user I/F 50 and outputs information based on the processing results to the user I/F 50.

The memory 10 is a RAM (RANDOM ACCESS MEMORY), for example, and stores programs executed by the processor 30 and necessary information. In the present embodiment, the memory 10 stores a model transferability determination program 11 including a data input program 12, a static feature information modeling program 13, a transfer source data selection program 14, a data extension program 15, and a transfer model evaluation program 16.

The data input program 12 by being executed by the processor 30 receives static feature data related to a target task, observation data, parameters of an analysis model, and a feature value generation file from users.

Here, the static feature data is numerical data and/or text data indicating static features of a target (a target object and a target event) of a target task, and for example, is information on standards of a product which is a target object and the type and quantity of a raw material. The observation data is data obtained from the target as a behavior thereof, and for example, is observation data related to the temperature and air volume affecting the raw material during manufacturing of the product which is a target object and image data obtained by observing the product being manufactured. The feature value generation file is a file in which rules for processing the observation data to obtain feature values are described.

The static feature information modeling program 13 by being executed by the processor 30 models the static feature data with observation data to construct a static feature model. Modeling refers to generating a numerical expression which is based on observation data and outputs static feature data. For example, when static feature data y is modeled using two pieces of observation data x₁ and x₂, a static feature model of y=0.15*x₁+0.01*x₂ is generated.

The transfer source data selection program 14 by being executed by the processor 30 receives static feature data related to a transfer destination task and selects static feature data related to a transfer source task at the nearest distance from the static feature data related to the transfer destination task.

The data extension program 15 by being executed by the processor 30 extends the observation data of the transfer destination task to extended observation data on the basis of the static feature model. Here, the extended observation data is data obtained by processing observation data related to a target task in order to solve the target task using the analysis model generated for another task.

The transfer model evaluation program 16 by being executed by the processor 30 determines whether the analysis model of the transfer source can be transferred to a transfer destination task by applying the extended observation data of the transfer destination to the analysis model of the transfer source to calculate a generalization error of the analysis model. Here, a generalization error is a value based on a difference between an output value and a measured value when observation data different from the observation data used for generating the analysis model is input to the analysis model.

Some or all of the data input program 12, the static feature information modeling program 13, the transfer source data selection program 14, the data expansion program 15, and the transfer model evaluation program 16 may be integrated and the programs may be configured separately. Some or all of the data input program 12, the static feature information modeling program 13, the transfer source data selection program 14, the data expansion program 15, and the transfer model evaluation program 16 may be realized as a plurality of programs.

The storage 20 is a hard disk, a flash memory, or the like, for example, and stores a static feature data storage unit 21, an observation data storage unit 22, an analysis model storage unit 23, a static feature model storage unit 24, an extended data storage unit 25, a model transferability storage unit 26, and various programs called into the memory 10.

The static feature data storage unit 21 stores the static feature data received from users. The observation data storage unit 22 stores the observation data received from users. The analysis model storage unit 23 stores information related to the analysis model that models the output for solving the target task using the observation data. The static feature model storage unit 24 stores information related to the analysis model that models the static feature data using the observation data. The extension data storage unit 25 stores the extended observation data. The model transferability storage unit 26 stores information for determining whether the analysis model can be transferred.

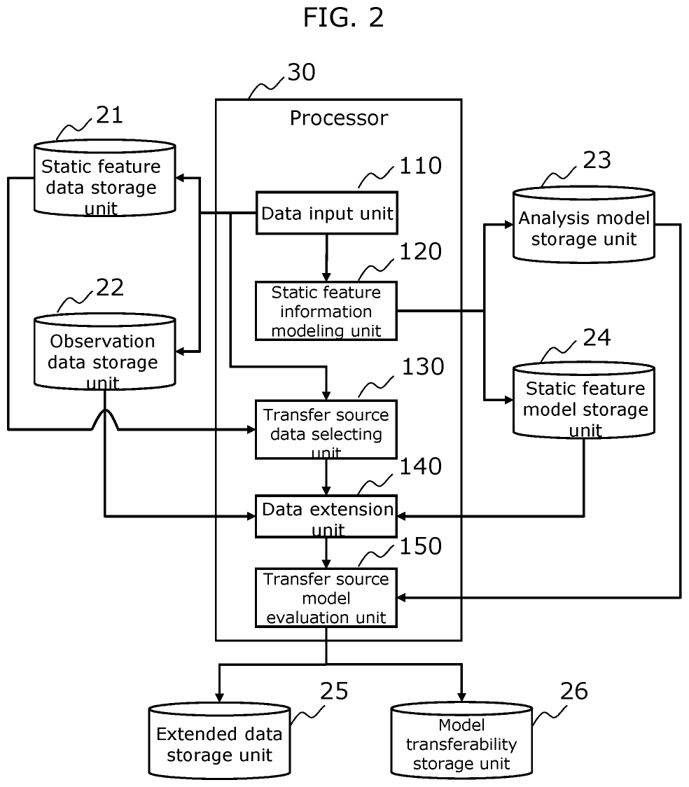

FIG. 2 is a schematic block diagram of an analysis model transferability determination apparatus according to the embodiment.

The analysis model transferability determination apparatus 1 includes a data input unit 110, a static feature information modeling unit 120, a transfer source data selecting unit 130, a data extension unit 140, and a transfer source model evaluation unit 150.

The data input unit 110 is realized by the processor 30 executing the data input program 12. The static feature information modeling unit 120 is realized by the processor 30 executing the static feature information modeling program 13. The transfer source data selecting unit 130 is realized by the processor 30 executing the transfer source data selection program 14. The data expansion unit 140 is realized by the processor 30 executing the data expansion program 15. The transfer source model evaluation unit 150 is realized by the processor 30 executing the transfer model evaluation program 16.

The data input unit 110 receives static feature data (first static feature data and second static feature data) and observation data (first observation data and second observation data) from users and stores the same in the static feature data storage unit 21 and the observation data storage unit 22, respectively. The data input unit 110 transmits the static feature data and the observation data to the static feature information modeling unit 120. The data input unit 110 transmits the static feature data and the observation data to the transfer source data selecting unit 130.

The static feature information modeling unit 120 receives the static feature data and the observation data from the data input unit 110, constructs a static feature model, and records the static feature model in the static feature model storage unit 24. The static feature data and the observation data may be received from the static feature data storage unit 21 and the observation data storage unit 22.

The transfer source data selecting unit 130 receives the static feature data (second static feature data) of the transfer destination from the data input unit 110, receives a group of pieces of static feature data (first static feature data) of the transfer source from the static feature data storage unit 21, selects a static feature record of the transfer source used for processing on the basis of the static feature data of the transfer destination and the static feature data group of the transfer source, and transmits a transfer source task ID related to the static feature record to the data extension unit 140. Here, the transfer source task ID is an ID for identifying a target transfer source task.

The data extension unit 140 receives the transfer source task ID from the transfer source data selecting unit 130, receives the observation data (second observation data) related to the transfer destination task from the observation data storage unit 22, receives the static feature model from the static feature model storage unit 24, calculates the extended observation data on the basis of the observation data related to the transfer source task ID and the transfer destination task and the static feature data of the transfer source, and transmits the extended observation data to the transfer source model evaluation unit 150. Here, the extended observation data is data obtained by extending the observation data related to a target task to data for another task (an analysis model for another task).

The transfer source model evaluation unit 150 receives the observation data related to the transfer destination task, the extended observation data, and the transfer source task ID from the data extension unit 140, acquires an analysis model related to the transfer source model from the analysis model storage unit 23 on the basis of the transfer source task ID, applies the extended observation data to the analysis model to calculate a generalization error of the extended observation data for the transfer source model, applies the observation data to the analysis model to calculate a generalization error of the observation data with respect to the transfer source model, calculates a post-transfer performance improvement rate, a transferability, and a transferability determination result on the basis of the generalization error and the generalization error of the transfer source data with respect to the transfer source model, records the extended observation data in the extended data storage unit 25, and records the post-transfer performance improvement rate, the transferability, and the transferability determination result in the model transferability storage unit 26. Here, the post-transfer performance improvement rate is a performance improvement rate of the transfer destination data to the transfer source model before and after data extension and is represented by a numerical value. The transferability is a probability that the transfer source model can be transferred to a transfer destination task, and is represented by a numerical value in the range of 1 to 100, for example. The transferability determination result is an example of information related to the transferability, and is a result of determination on whether the transfer source model can be transferred to a transfer destination task, and is represented by a binary value indicating whether it is possible or not.

Next, the static feature data storage unit 21, the observation data storage unit 22, the analysis model storage unit 23, the static feature model storage unit 24, the extended data storage unit 25, and the model transferability storage unit 26 stored in the storage 20 will be described in detail.

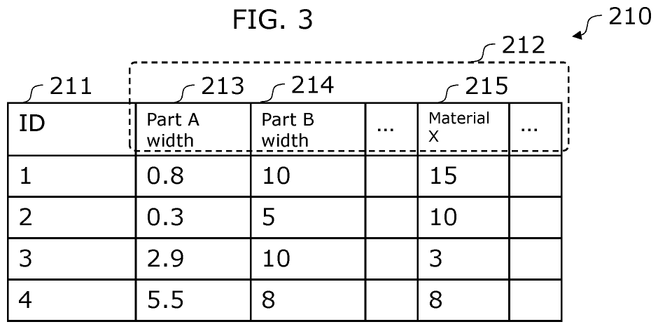

FIG. 3 is a diagram illustrating a configuration example of a static feature data table.

The static feature data table 210 is stored in the static feature data storage unit 21. A plurality of entries including an ID 211 and a static feature factor group 212 is registered in the static feature data table 210. The ID 211 is an identification number for uniquely identifying the static feature data. The static feature factor group 212 includes a plurality of static feature factors, and in the example of FIG. 3, includes a part A width 213, a part B width 214, and raw material X 215, and the like. The part A width 213 is the width of the part A of a product. The part B width 214 is the width of the part B of a product. The raw material X 215 is the proportion (percentage) of a raw material X of a product.

For example, in FIG. 3, the entry in which the ID 211 of the static feature data table 210 is “1” indicates that the part A width 213 as a static feature factor is “0.8”, the part B width 214 is “10”, and the raw material X 215 is “15”.

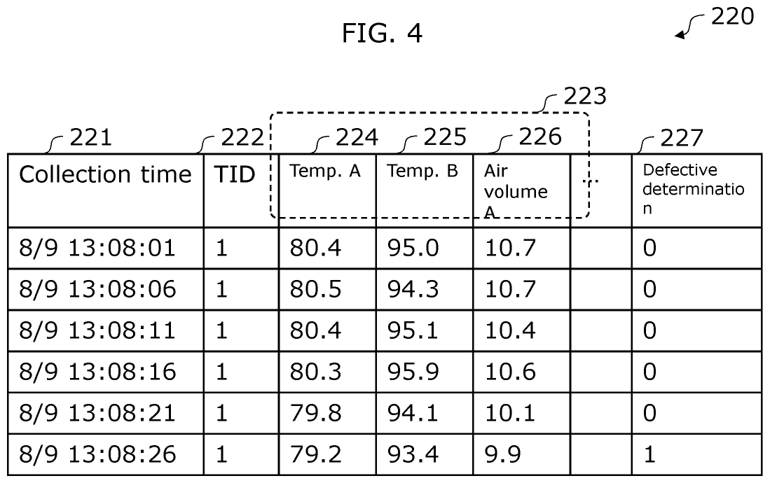

FIG. 4 is a diagram illustrating a configuration example of an observation data table.

The observation data table 220 is stored in the observation data storage unit 22. A plurality of entries including a collection time 221, a TID 222, an observation data group 223, and a failure determination 227 is registered in the observation data table 220. The collection time 221 is a time point at which observation data was collected from sensors. The TID 222 is an identification number for uniquely identifying a task. The observation data group 223 includes observation data (sensor data) obtained by a plurality of sensors, and in the example of FIG. 4, includes a temperature A 224, a temperature B 225, an air volume A 226, and the like. The temperature A 224 is the temperature A observed by a temperature A sensor. The temperature B 225 is the temperature B observed by a temperature B sensor. The air volume A 226 is the air volume A observed by an air volume A sensor. A failure determination 227 is an examination result for a product manufactured when the observation data was collected, and in the example of FIG. 4, “0” is set when the product is not-defective and “1” is set when a product is defective.

For example, in FIG. 4, the entry in which the collection time 221 of the observation data table 220 is “8/9 13:08:01” indicates that for a task of which the TID 222 is “1”, the temperature A 224 is “80.4”, the temperature B 225 is “95.0”, and the air volume A 226 is “10.7”, and a product of which the failure determination 227 is “0” is manufactured at the collection time.

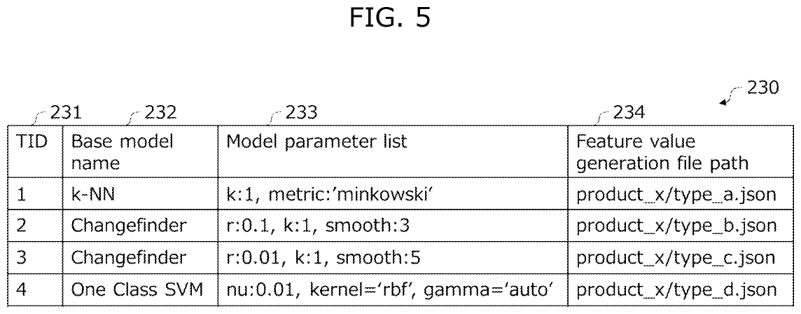

FIG. 5 is a diagram illustrating a configuration example of an analysis model table.

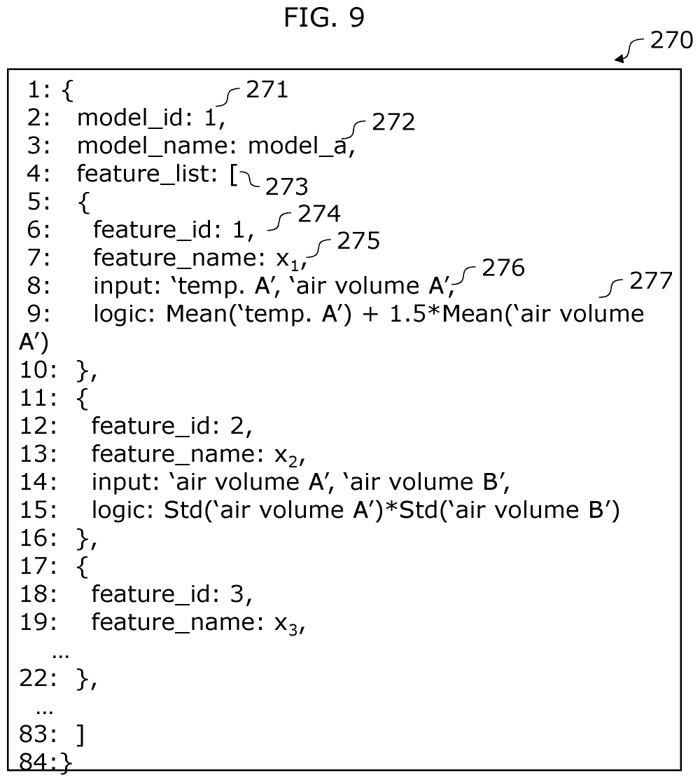

The analysis model table 230 is stored in the analysis model storage unit 23. A plurality of entries including a TID 231, a base model name 232, a model parameter list 233, and a feature value generation file path 234 is registered in the analysis model table 230. The TID 231 is an identification number for uniquely identifying a task. The base model name 232 is a method name used for generating an analysis model. The model parameter list 233 is a list of parameter names and parameter values related to the base model name 232. The feature value generation file path 234 indicates the path to the feature value generation file 270 (see FIG. 9) that describes a feature value generation method.

For example, in FIG. 5, the entry in which the TID 231 of the analysis model table 230 is “1” indicates that the base model name 232 is “k-NN”, the model parameter list 233 is “k:1, metric: ‘minkowski’”, and the feature value generation file path 234 is “product_x/type_a.json”.

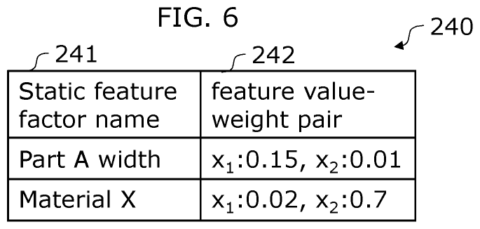

FIG. 6 is a diagram illustrating a configuration example of a static feature model table.

The static feature model table 240 is stored in the static feature model storage unit 24. A plurality of entries including a static feature factor name 241 and a feature value-weight pair 242 is registered in the static feature model table 240. The static feature factor name 241 is the name of a static feature factor. The feature value-weight pair 242 indicates a list of pairs of a feature value name and a weight with respect to a feature value of the feature value name.

For example, in FIG. 6, the entry in which the static feature factor name 241 of the static feature model table 240 is “part A width” indicates that the feature value-weight pair 242 is “x₁:0.15, x₂:0.01”.

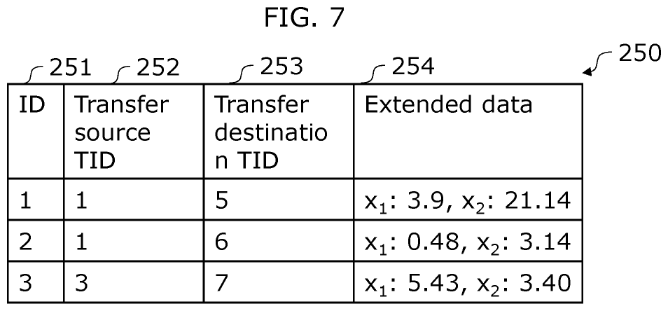

FIG. 7 is a diagram illustrating a configuration example of an extended data table.

The extended data table 250 is stored in the extended data storage unit 25. A plurality of entries including an ID 251, a transfer source TID 252, a transfer destination TID 253, and an extended data 254 is registered in the extended data table 250. The ID 251 is an identification number for uniquely identifying an entry. The transfer source TID 252 is an identification number for uniquely identifying a transfer source task. The transfer destination TID 253 is an identification number for uniquely identifying a transfer destination task. The extended data 254 indicates a list of pairs of a feature value name and feature value.

For example, in FIG. 7, the entry in which the ID 251 of the extended data table 250 is “1” indicates that the transfer source TID 252 is “1”, the transfer destination TID 253 is “5”, and the extended data 254 is “x₁:3.9, x₂:21.14”.

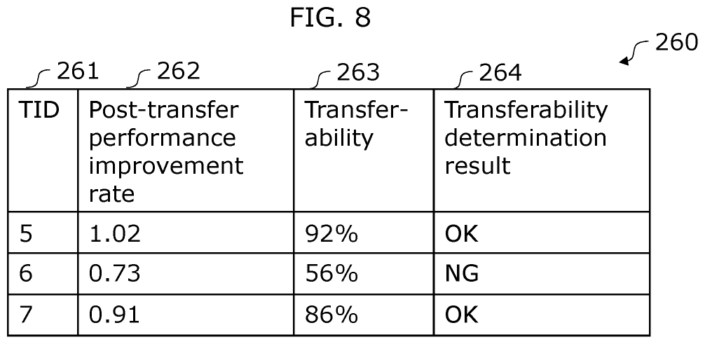

FIG. 8 is a diagram illustrating a configuration example of a model transferability table.

The model transferability table 260 is stored in the model transferability storage unit 26. A plurality of entries including a TID 261, a post-transfer performance improvement rate 262, a transferability 263, and a transferability determination result 264 is registered in the model transferability table 260. The TID 261 is an identification number for uniquely identifying a task. The post-transfer performance improvement rate 262 is a proportion of performance improvement before and after expansion of the observation data. The transferability 263 is the probability that the transfer source model can be transferred to a transfer destination task. The transferability determination result 264 is a determination result on whether the transfer source model can be transferred to a transfer destination task.

For example, in FIG. 8, the entry in which the TID 261 of the model transferability table 260 is “5” indicates that the post-transfer performance improvement rate 262 is “1.02”, the transferability 263 is “92%”, and the transferability determination result 264 is “OK”.

FIG. 9 is a diagram illustrating an example of a feature value generation file.

The feature value generation file 270 is stored in the static feature model storage unit 24. The feature value generation file 270 includes description about a method for generating a feature value of a static feature model. The feature value generation file 270 is referred to on the basis of the feature value generation file path 234 of the analysis model table 230.

An entry including a model_id 271, a model_name 272, and a feature_list 273 is described in the feature value generation file 270. The model_id 271 is an identification number for uniquely identifying a model. The model_name 272 is the name of a model. The feature_list 273 is a list that retains information on a plurality of feature values. An entry including a feature_id 274, a feature_name 275, an input 276, and a logic 277 is described in the feature_list 273. The feature_id 274 is an identification number for uniquely identifying a feature value. The feature_name 275 is a feature value name. The input 276 is an observation data name used for generating a feature value. The input 276 is one or more observation data names among the pieces of observation data included in the observation data group 223 of the observation data table 220. The logic 277 is a calculation formula for generating a feature value.

For example, in FIG. 9, the entry in which the model_id 271 of the feature value generation file 270 is “1” indicates that the model_name 272 is “model_a”, and three or more entries are included in the feature_list 273. The entry in which the feature_id 274 of the feature_list 273 is “1” indicates that the feature_name 275 is “x₁”, the input 276 is “‘temperature A’, ‘air volume A’”, and the logic 277 is “Mean (‘temperature A’)+1.5*Mean (‘air volume A’)”. Here, Mean(x) is a function for calculating the mean of a feature value name x.

Next, a processing operation of the analysis model transferability determination apparatus 1 will be described.

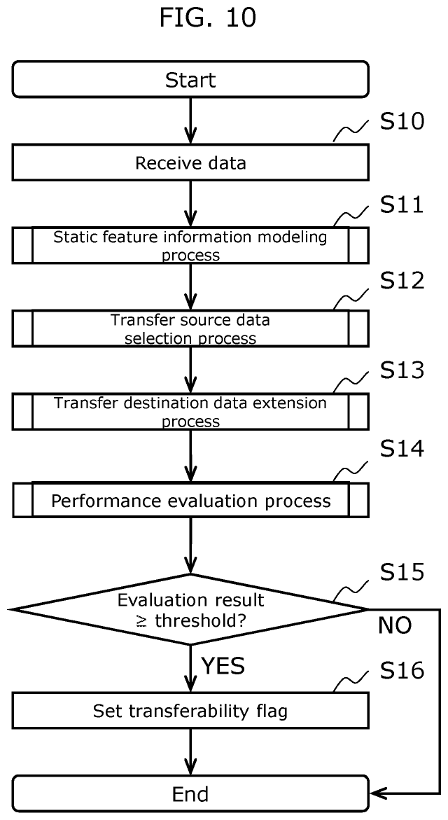

FIG. 10 is a flowchart illustrating an example of a main process of the analysis model transferability determination apparatus according to the embodiment.

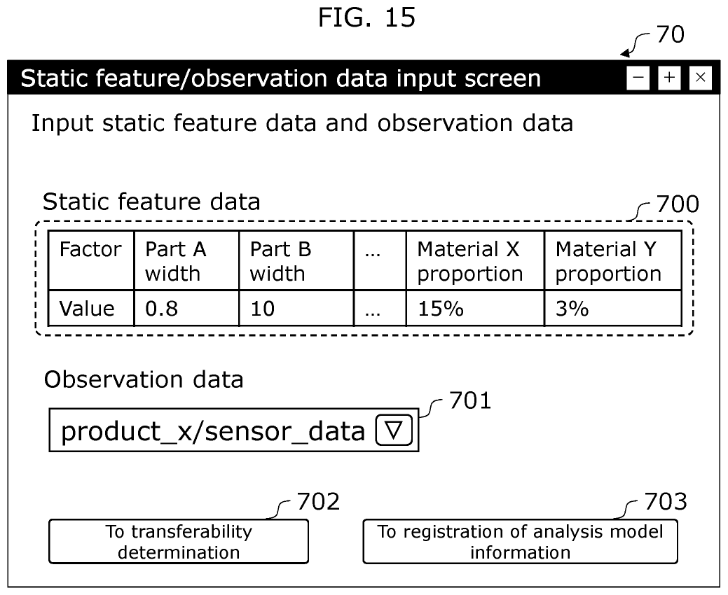

First, the data input unit 110 stores the static feature data and the observation data related to a transfer source task input from users via a data input screen 70 (see FIG. 15) to be described later in the static feature data table 210 of the static feature data storage unit 21 and the observation data table 220 of the observation data storage unit 22, respectively (step S10).

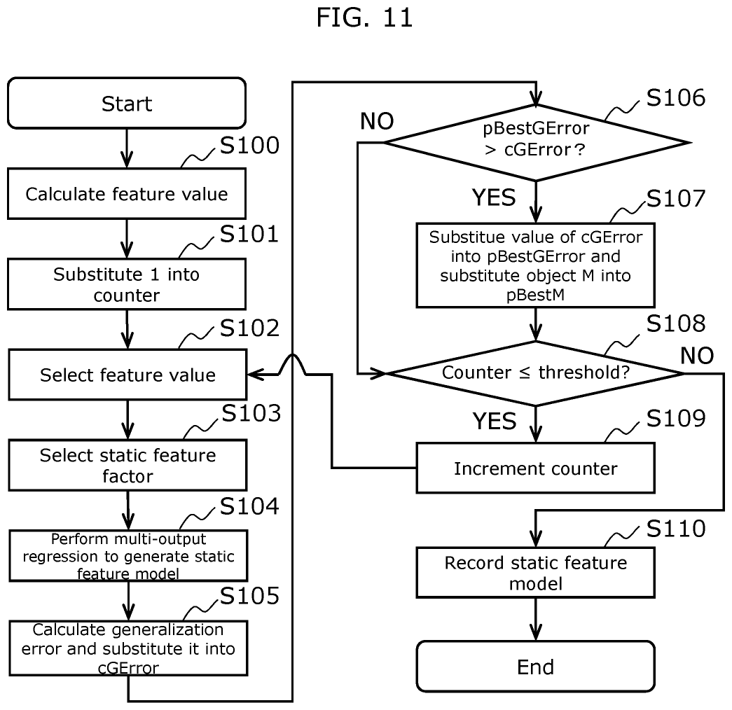

Subsequently, the static feature information modeling unit 120 executes a static feature information modeling process (see FIG. 11) (step S11). In the static feature information modeling process, the static feature information modeling unit 120 acquires the static feature data and the observation data from the data input unit 110, models the static feature data using the observation data to construct the static feature model, and records the static feature model in the static feature model storage unit 24.

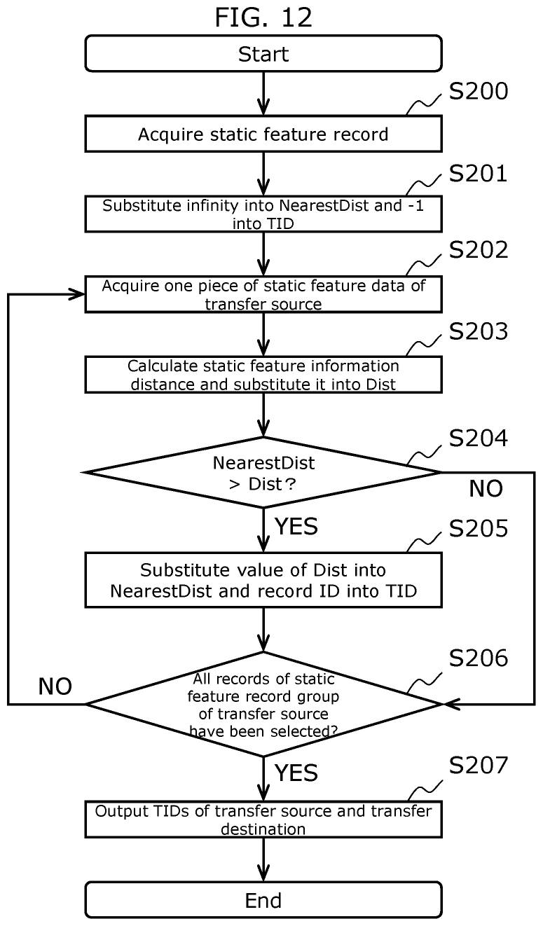

Subsequently, the transfer source data selecting unit 130 executes a transfer source data selection process (see FIG. 12) (step S12). In the transfer source data selection process, the transfer source data selecting unit 130 receives the static feature data related to the transfer destination task from the data input unit 110, acquires the static feature data related to a prescribed transfer source task from the static feature data storage unit 21 on the basis of the static feature data related to the received transfer destination task, and transmits the transfer source task ID related to the transfer source task to the data extension unit 140.

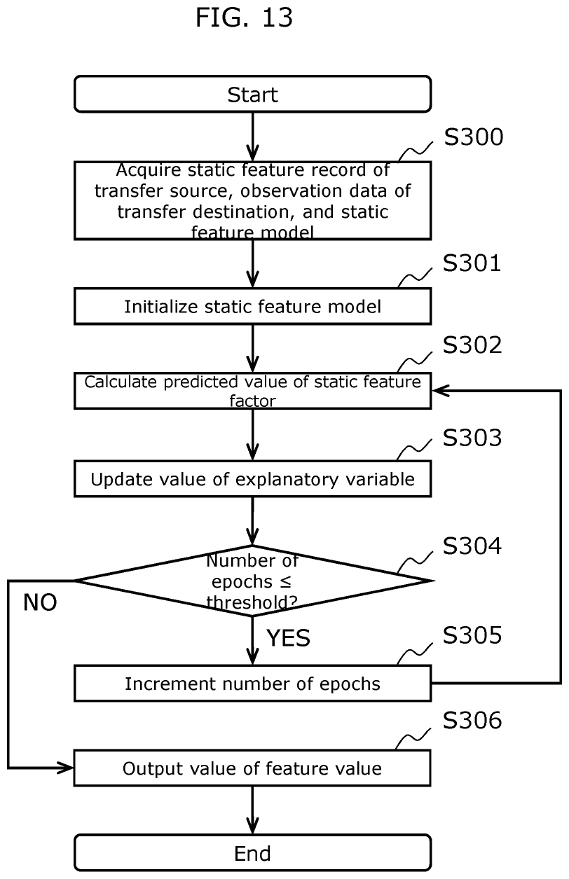

Subsequently, the data extension unit 140 executes the transfer destination data extension process (see FIG. 13) (step S13). In the transfer destination data extension process, the data extension unit 140 acquires the observation data (first observation data) related to the transfer source task from the observation data storage unit 22 on the basis of the transfer source task ID received from the transfer source data selecting unit 130, acquires the observation data (second observation data) related to the transfer destination task from the observation data storage unit 22, acquires the static feature model from the static feature model storage unit 24, calculates the extended observation data on the basis of the observation data related to the transfer source task ID, the observation data related to the transfer destination task, and the static feature model, and transmits the extended observation data and the transfer source task ID to the transfer source model evaluation unit 150.

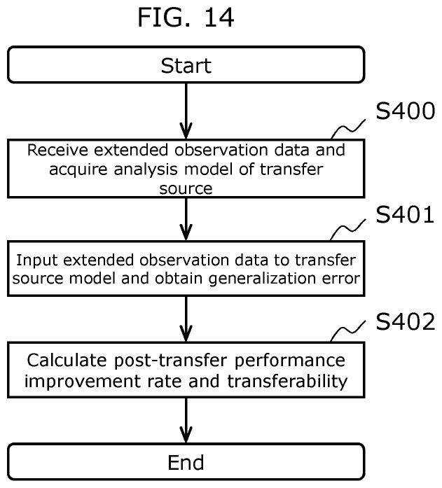

The transfer source model evaluation unit 150 executes a performance evaluation process (see FIG. 14) (step S14). In the performance evaluation process, the transfer source model evaluation unit 150 acquires an analysis model related to the transfer source model from the analysis model storage unit 23 on the basis of the transfer source task ID received from the data extension unit 140 and calculates an evaluation result (transferability) on the observation data of the analysis model on the basis of the extended observation data received from the data expansion unit 140 and the acquired analysis model.

Subsequently, the transfer source model evaluation unit 150 determines whether the evaluation result is equal to or larger than a threshold (step S15). When the evaluation result is equal to or larger than the threshold (step S15: YES), the transfer source model evaluation unit 150 sets a transferability flag meaning that the transferability is high to set the transferability determination result 264 of the model transferability table 260 to “OK”, for example (step S16), and ends the process. When the evaluation result is smaller than the threshold (step S15: NO), the transfer source model evaluation unit 150 does nothing and ends the process.

Subsequently, the static feature information modeling process corresponding to step S11 of FIG. 10 will be described in detail.

FIG. 11 is a flowchart illustrating an example of a static feature information modeling process according to the embodiment.

First, the static feature information modeling unit 120 acquires the observation data from the observation data storage unit 22, determines a function (a calculation formula) for calculating one or more feature values on the basis of the observation data, and calculates the feature value (step S100). The type of feature value to be calculated may be instructed by a user, for example.

Subsequently, the static feature information modeling unit 120 initializes various variables and the like (step S101).

Specifically, the static feature information modeling unit 120 substitutes 1 into a variable counter, substitutes infinity into a variable cGError and a variable pBestGError, and substitutes empty values into an object M and an object pBestM. Here, an object is a data structure including an arbitrary number of variables and functions. Although infinity is substituted into the variable cGError and the variable pBestGError, when it is not possible to represent infinity using a program, a prescribed value given by a user may be used instead of infinity, for example.

Subsequently, the static feature information modeling unit 120 selects some or all feature values among the feature values calculated in step S100 as a processing target (step S102), receives the static feature data from the static feature data storage unit 21, and selects some or all static feature factors within the static feature data as a processing target (step S103). Here, the static feature factor is a factor that constitutes the static feature data, and for example, is the width of the part A or the proportion of the raw material X in the target product. As a method of selecting a processing target from a feature value and a method of selecting a processing target from static feature data, the processing target may be selected randomly and may be selected according to prescribed rules (for example, rules designated by a user).

Subsequently, the static feature information modeling unit 120 executes multi-output regression to execute a process of generating a static feature model (step S104). Specifically, the static feature information modeling unit 120 divides the observation data and the static feature data into two pieces of data including training data and test data. Here, as a method of dividing the observation data and the static feature data into two pieces of data including the training data and the test data, the observation data and the static feature data may be divided into two pieces of data in units of products, for example. Subsequently, the static feature information modeling unit 120 executes multi-output regression using the training data using the static feature factor selected in step S103 as an objective variable and the feature value selected in step S102 as an explanatory variable to generate a static feature model, and substitutes the static feature factors, the feature value, and the parameters of the static feature model into the object M.

The processing of the multi-output regression by the static feature information modeling unit 120 may be executed in the following procedures, for example.

### Procedure 1

A weight wᵢⱼ in Equation (1) below is determined randomly.

$${y}_{i}^{i t e r} ( {x}_{( n )} ) = {\sum }_{i = 1}^{m} {w}_{i j}^{i t e r} {x}_{( n ) j} \qquad ( 1 )$$

Here, m is the number of feature values, iter is the number of iterations of the multi-output regression processing, wᵢⱼ^{iter} is the weight an i-th static feature factor in an iter-th iteration with respect to a j-th feature value, x₍ₙ₎ⱼ is a j-th feature value of an n-th task (a task for an n-th product), x₍ₙ₎ is a vector of a feature value group of an n-th task, and yᵢ^{iter} (x₍ₙ₎) is a predicted value of an i-th static feature factor calculated using the feature value group x₍ₙ₎ of an iter-th iteration.

### Procedure 2

The feature value and the static feature data are input to Equation (2) below to update the weight value.

$${w}_{ij}^{iter + 1} = {w}_{ij}^{iter} - η {\sum }_{n = 1}^{N} ( {y}_{i}^{iter} ( {x}_{( n )} ) - {y}_{( n ) i} ) {x}_{( n ) j} \qquad ( 2 )$$

Here, wᵢⱼ^{ter}, x₍ₙ₎ⱼ, x₍ₙ₎, and yᵢ^{iter}(x₍ₙ₎) have the same signs as those of Equation (1), N is the number of tasks, y₍ₙ₎ᵢ is a measured value of an i-th static feature factor of an n-th task, and η is a training rate. η is an arbitrary value and may be set by a user.

### Procedure 3

A training error E (Eₜᵣₐᵢₙ) is calculated using Equation (3) below, and the flow proceeds to Procedure 4 when a variance including past x times of training errors is equal to or smaller than a threshold or when the value of the variable iter is larger than a threshold. In other cases, the variable iter is incremented and the flow returns to Procedure 2.

$$E ( f , x , y ) = {\sum }_{i = 1}^{k} {\sum }_{n = 1}^{N} {( {f}_{i} ( {x}_{( n )} ) - {y}_{( n ) i} )}^{2} \qquad Equation ( 3 )$$

Here, f is a function vector (f₁, f₂, . . . , fₖ) and fᵢ indicates an i-th function. k is the number of functions. x is a training data vector (x₍₁₎, x₍₂₎, . . . , x₍ₙ₎). x₍ₙ₎ is a vector of a feature value group of an n-th task. y is a measured value matrix of which the (i,n) component is y₍ₙ₎ᵢ, and y₍ₙ₎ᵢ is a measured value corresponding to a i-th function of an n-th task.

When Equation (3) is to be used in Procedure 3, yᵢ^{iter} is input to fᵢ, training data is input to x, and static feature data corresponding to the training data is input to y.

### Procedure 4

The weight wᵢⱼ is output. In this way, it is possible to determine the weight appropriately when the variance of the generalization error E is equal to or smaller than a threshold or when processing is repeated for a prescribed number of times. When the variance of the generalization error E exceeds the threshold, the static feature factor selected at that time may be removed from a static feature model so that a static feature model in which only the static feature factors within the threshold are used as an objective variable is obtained.

Subsequently, the static feature information modeling unit 120 calculates a generalization error E (Eₜₑₛₜ) of the static feature model is calculated according to Equation (3) using the test data and the static feature model and is substituted into the variable cGError (step S105). When Equation (3) is to be used in step S105, the static feature model calculated (trained) in advance in Procedure 3 of step S104 (that is, a function vector (y₁, y₂, . . . , yₖ) for predicting a static feature factor using a feature value as an input) is input to f, the test data is input to x, and the static feature data corresponding to the test data is input to y. yᵢ is a function for predicting an i-th static feature factor.

Steps S104 and S105 may be executed repeatedly to calculate the mean of the generalization error E and the calculated mean may be substituted into the variable cGError while changing the method of dividing the training data and the test data in step S104.

Subsequently, the static feature information modeling unit 120 determines whether the value (the value of the smallest generalization error ever) of the variable pBestGError is larger than the value (the value of the generalization error calculated immediately before) of the variable cGError (step S106). When the value of the variable pBestGError is larger than the value of the variable cGError (step S106: YES), it means that the generalization error calculated immediately before is smaller and the statics meta-information is more accurate. Therefore, the static feature information modeling unit 120 substitutes the value of the variable cGError into the variable pBestGError, substitutes the object M into the object pBestM (step S107), and proceeds to step S108. On the other hand, when the value of the variable pBestGError is not larger than the value of the variable cGError (step S106: NO), the static feature information modeling unit 120 proceeds to step S108.

Subsequently, in step S108, the static feature information modeling unit 120 determines whether the variable counter is equal to or smaller than a threshold.

When the variable counter is equal to or smaller than a threshold (step S108: YES), it means that the processing has not been repeated for a number of times exceeding the prescribed number of times. Therefore, the static feature information modeling unit 120 increments the variable counter by +1 (step S109) and executes the processing starting with step S102 again. When the processing starting with step S102 is executed again, the static feature information modeling unit 120 does not select the combination of the static feature factor and the feature value selected as a processing target in selection of the feature value in step S102 and the static feature factor in step S103.

On the other hand, when the value of the variable counter is not equal to or smaller than the threshold (step S108: NO), it means that the processing has been repeated for a number of times exceeding the prescribed number of times. Therefore, the static feature information modeling unit 120 records the information (that is, the information on the static feature model of which the generalization error is the smallest among the processed static feature models) on the variable included in the object pBestM in the static feature model storage unit 24, creates the feature value generation file 270 on the basis of the calculation formula of the feature value determined in step S100 and the content of the object pBestM (step S110), and ends the processing.

According to the static feature model generation process, a static feature model of which the generalization error of the static feature data is the smallest among a plurality of static feature models is determined as a static feature model to be used in the subsequent processing. In the above-described example, although a static feature model of which the generalization error of the static feature data is the smallest among a plurality of static feature models is determined as a static feature model to be used in the subsequent processing, a static feature model of which the generalization error is equal to or smaller than a prescribed threshold may be determined as a static feature model to be used in the subsequent processing.

Next, a specific example of the static feature model generation process will be described. In a specific example, a process of generating a model for a task for determining defects in a product will be described, and it is assumed that models are constructed for respective products. There are four target tasks having the task IDs of 1, 2, 3, and 4, and a static feature model is generated using the static feature data and the observation data of the tasks. The static feature data is data including the static feature factor related to three types including the part A width, the part B width, and the raw material X quantity, and the observation data is numerical data collected in a certain period from the temperature A sensor, the temperature B sensor, the air volume A sensor, and the air volume B sensor. The feature value is the mean and the largest value of the values calculated for the respective sensors, and the threshold used in step S108 is 2, and the threshold of the variance of the generalization error E in Procedure 4 of step S104 is 1.5.

The static feature information modeling unit 120 receives the four types of numerical data of the temperature A sensor, the temperature B sensor, the air volume A sensor, and the air volume B sensor from the observation data storage unit 22 in step S100 and calculates the mean and the largest value for each sensor, of the four types of data. As a result, the mean and the largest value for each sensor are calculated as a feature value with respect to the tasks having the task IDs of 1, 2, 3, and 4. The calculation results of the feature value are such that the means of the temperature A sensor are 10, 20, 25, and 15 for the task IDs of 1, 2, 3, and 4, respectively.

In step S101, the static feature information modeling unit 120 substitutes 1 into the variable counter, substitutes infinity into the variable cGError and the variable pBestGError, and substitutes empty values into the object M and the object pBestM.

Subsequently, in step S102, the static feature information modeling unit 120 selects a feature value. For example, the static feature information modeling unit 120 selects the mean of the temperature A sensor and the mean of the air volume A sensor.

Subsequently, in step S103, the static feature information modeling unit 120 selects a static feature factor. For example, the static feature information modeling unit 120 selects the part A width and the raw material X quantity.

Subsequently, in step S104, the static feature information modeling unit 120 divides the observation data and the static feature data into training data and test data. As a result of the division, for example, the observation data and the static feature data for the tasks having the task IDs of 1, 2, and 3 are used as the training data, and the observation data and the static feature data for the task having the task ID of 4 are used as the test data.

Subsequently, the static feature information modeling unit 120 performs multi-output regression to calculate the static feature model. As a result, Equations (4) and (5) below, for example, are obtained as the static feature model.

y_{part_a}=0.15*x_{mean(temp_1)}+0.01*x_{mean(air_a)} (4)

y_{material_x}=0.02*x_{mean(temp_1)}+0.7*x_{mean(air_a)} (5)

Here, y_{part_a}, y_{material_x}, X_{mean(temp_1)}, and X_{mean(air_a)} are variables indicating the part A width, the raw material X quantity, the mean of the value of the temperature A sensor, and the mean of value of the air volume A sensor.

Subsequently, the static feature information modeling unit 120 substitutes the variables and parameters of Equations (4) and (5) into the object M. In this example, although the variables and parameters are substituted into the object M, the formula itself including the variables and parameters may be stored in the object M, for example.

Subsequently, in step S105, the static feature information modeling unit 120 substitutes the feature value of the task having the task ID of 4 into Equations (4) and (5) and calculates the generalization error using Equation (3). For example, if the part A width, the raw material X quantity, the mean of the value of the temperature A sensor, and the mean of the value of the air volume A sensor for the task having the task ID of 4 are 5.5, 8, 80, and 10, respectively, the generalization error is calculated as ((0.15*80+0.01*10)−5.5)²+((0.02 80+0.7*10)−8)²=43.92 using these values and Equations (3), (4), and (5).

In step S106, the static feature information modeling unit 120 compares the values of the variable pBestGError and the variable cGError. Since the value of the variable pBestGError is infinity, the value of the variable cGError is 43.92, and the value of the variable pBestGError is larger, the flow proceeds to step S107.

In step S107, the static feature information modeling unit 120 substitutes 43.92 which is the value of the variable cGError into the variable pBestGError and substitutes the object M into the object pBestM.

Subsequently, in step S108, the static feature information modeling unit 120 compares the value of the variable counter with a threshold. In this example, the value of the variable counter is 1, the threshold is 2, and the variable counter is equal to or smaller than the threshold, the flow proceeds to step S109.

The static feature information modeling unit 120 increments the variable counter by 1 to 2 in step S109 and executes step S102.

The static feature information modeling unit 120 executes step S102 for the second time and subsequently executes the steps up to S106. Here, when the variable pBestGError is equal to or smaller than the variable cGError, the static feature information modeling unit 120 executes steps S108 and S109 to set the value of the variable counter to 3.

Subsequently, the static feature information modeling unit 120 executes step S102 for the third time and subsequently executes steps up to S106. When the variable pBestGError is equal to or smaller than the variable cGError, the static feature information modeling unit 120 executes step S108. Since the variable counter is 3 and is larger than the threshold of 2, the static feature information modeling unit 120 proceeds to step S110, records the information included in the object pBestM in the static feature model storage unit 24, and ends the processing. Specifically, the static feature information modeling unit 120 records the value of the weight and the variable names included in Equations (4) and (5).

According to the static feature model generation process, the analysis model transferability determination apparatus 1 can express the correlation between the static feature factor and the sensor in a formula form and can understand the change in the observation data accompanied by the change in the static feature factor. In this way, it is possible to understand the change in the manufacturing parameter resulting from the differences in standards of products and to use the same in determining whether the analysis model generated on the basis of the manufacturing parameter can be reused between products.

Next, the transfer source data selection process corresponding to step S12 of FIG. 10 will be described in detail.

FIG. 12 is a flowchart illustrating an example of the transfer source data selection process according to the embodiment.

First, the transfer source data selecting unit 130 receives the static feature record related to the transfer destination task from the data input unit 110 and then acquires a static feature record group related to the transfer source task from the static feature data storage unit 21 (step S200).

The transfer source data selecting unit 130 substitutes infinity into the variable NearestDist and −1 into the variable TID (step S201).

Subsequently, the transfer source data selecting unit 130 selects one static feature record among the static feature record group related to the transfer source task (step S202).

Subsequently, the transfer source data selecting unit 130 calculates the distance between the static feature record of the transfer destination task and the selected static feature record related to the transfer source task and substitutes the calculated value into a variable Dist (step S203). Here, the distance calculated between the records may be the Euclid distance, for example, and a cosine similarity may be used and a distance calculated using other arbitrary methods may be used.

Subsequently, the transfer source data selecting unit 130 determines whether the variable NearestDist is larger than the variable Dist (step S204). When the variable NearestDist is larger than the value of the variable Dist (step S204: YES), the transfer source data selecting unit 130 proceeds to step S205. When the variable NearestDist is not larger than the value of the variable Dist (step S204: NO), the flow proceeds to step S206.

In step S205, the transfer source data selecting unit 130 substitutes the value of the variable Dist into the variable NearestDist, substitutes the TID of the selected static feature record of the transfer source into the variable TID, and proceeds to step S206.

In step S206, the transfer source data selecting unit 130 determines whether all records of the static feature record group of the transfer source have been selected as the processing target. When all records of the static feature record group of the transfer source have been selected as the processing target (step S206: YES), the transfer source data selecting unit 130 proceeds to step S207. When all records of the static feature record group of the transfer source have not been selected as the processing target (step S206: NO), the transfer source data selecting unit 130 proceeds to step S202.

In step S207, the transfer source data selecting unit 130 outputs the values of the TIDs of the transfer source and the transfer destination to the data extension unit 140 and then ends the processing.

Next, a specific example of the transfer source data selection process will be described. In a specific example, a transfer source data selection process for generating a model for a task for determining defects in a product will be described, and it is assumed that models are constructed for the products of the transfer source task. There are five target tasks having the task IDs of 1, 2, 3, 4, and 5, the task having the task ID of 5 is a transfer destination task, and the other tasks are the transfer source tasks. The static feature record includes three types of static feature factors including the part A width, the part B width, and the raw material X quantity.

In step S200, the transfer source data selecting unit 130 receives the static feature record related to the transfer destination task having the task ID of 5 from the data input unit 110 and then receives the static feature records related to the transfer source tasks having the task IDs of 1, 2, 3, and 4 from the static feature data storage unit 21.

Subsequently, in step S201, the transfer source data selecting unit 130 substitutes infinity into the variable NearestDist and −1 into the variable TID.

Subsequently, in step S202, the transfer source data selecting unit 130 selects the static feature record related to the transfer source task having the task ID of 1.

Subsequently, in step S203, the transfer source data selecting unit 130 calculates the distance related to the static feature records of the transfer destination task and the transfer source task. Here, the static feature records of the transfer destination task are “1.0”, “10”, and “10” for the part A width, the part B width, and the relay network demand, respectively, and the static feature records of the transfer source task are “0.8”, “10”, and “15” for the part A width, the part B width, and the raw material X quantity, respectively. The distance related to the static feature records of the transfer destination task and the transfer source task is the Euclid distance. In this case, the transfer source data selecting unit 130 calculates the square root of (1.0−0.8)²+(10−10)²+(10−15)², and the distance of the static feature records of the transfer destination task and the transfer source task is calculated as 5.00. After that, the transfer source data selecting unit 130 substitutes 5.00 into the variable Dist.

Subsequently, in step S204, the transfer source data selecting unit 130 compares the NearestDist and the variable Dist. Since the comparison result shows that the value of the variable NearestDist is larger in this example, the transfer source data selecting unit 130 proceeds to step S205.

Subsequently, in step S205, the transfer source data selecting unit 130 substitutes 5.00 which is the value of the variable Dist into the variable NearestDist and substitutes the TID of the transfer source task of 1 into variable TID.

Subsequently, in step S206, the transfer source data selecting unit 130 determines whether all records of the static feature record group of the transfer source have been selected as the processing target. In this example, since the static feature record related to the tasks having the TIDs of 2, 3, and 4 among the static feature record group of the transfer source are not selected, the transfer source data selecting unit 130 proceeds to step S202.

After that, the transfer source data selecting unit 130 repeats the processing of steps S202 to S206 for three times and calculates the distance between each of the static feature records related to the transfer source tasks having the TIDs of 2, 3, and 4 and the static feature record related to the transfer destination task.

In step S206, the transfer source data selecting unit 130 proceeds to step S207 upon checking that all records of the static feature record group of the transfer source have been selected.

In step S207, the transfer source data selecting unit 130 outputs the values of the TIDs of the transfer destination and the transfer source to the data extension unit 140. In this example, the transfer source data selecting unit 130 outputs 5 which is the TID of the transfer destination task and 1 which is the TID of the transfer source task.

According to the transfer source data selection process, the analysis model transferability determination apparatus 1 can select a task which is easy to be transferred to a transfer destination task among a plurality of transfer source tasks and reduce the amount of man-hour of users selecting the transfer source task.

Next, the transfer destination data extension process corresponding to step S13 of FIG. 10 will be described in detail.

FIG. 13 is a flowchart illustrating an example of the transfer destination data extension process according to the embodiment.

First, the data extension unit 140 receives the values of the TIDs related to the transfer source and the transfer destination from the transfer source data selecting unit 130. After that, the data extension unit 140 acquires the static feature record of the transfer source on the basis of the TID of the transfer source and acquires the observation data of the transfer destination on the basis of the TID of the transfer destination. Moreover, the data extension unit 140 acquires information on the static feature model from the static feature model storage unit 24 (step S300).

Subsequently, the data extension unit 140 calculates the feature value using the observation data acquired in step S300. Moreover, the data extension unit 140 substitutes 1 into a variable epoch (step S301).

Subsequently, the data extension unit 140 calculates a predicted value (an objective variable) related to the static feature factor on the basis of the feature value (the explanatory variable) calculated in step S301 (step S302).

Subsequently, the data extension unit 140 updates the feature value on the basis of Equations (6) and (7) below (step S303).

x^{iter+1}=x^{iter}−H(x^{iter})⁻¹f(x^{iter}) (6)

f(x)=y(x)−y_{tr_src} (7)

Here, in Equation (6), x^{iter} is a feature value vector (xᵢ^{iter}, x₂^{iter}, . . . , xₘ^{iter}) of an iter-th iteration and m is the number of feature values. Moreover, H(x^{iter}) is a Jacobean matrix of x^{iter}. f(x^{iter}) is a vector obtained when x^{iter} is substituted into x in Equation (7).

In Equation (7), y(x) is a vector (y₁(x), y₂(x), . . . , yₖ(x)) related to the predicted value of the static feature factor, and yᵢ(x) is a predicted value related to an i-th static feature factor. Moreover, x is a feature value vector (x₁, x₂, . . . , xⱼ) and j is the number of feature values. Moreover, y_{tr_src} is a vector (y_{tr_src,1}, y_{tr_src,2}, . . . , y_{tr_src,m}) indicating the measured value of the static feature factor of the transfer source task and m is the number of static feature factors.

Subsequently, the data extension unit 140 determines whether the variable epoch (number of epochs) is equal to or smaller than a threshold (step S304). When the variable epoch is equal to or smaller than the threshold (step S304: YES), the data extension unit 140 increments the variable epoch (step S305) and proceeds to step S302. On the other hand, when the variable epoch is not equal to or smaller than the threshold (step S304: NO), the data extension unit 140 proceeds to step S306.

According to steps S302 to S305, the feature value based on the observation data related to the transfer destination task is used as an initial value of the explanatory variable of the static feature model, and a solution of the explanatory variable of the static feature model is calculated by an iterative method so that the difference between the value of the static feature data related to the transfer source task and the output value of the static feature model is reduced.

In step S306, the data extension unit 140 outputs the feature value after update or the observation data in which the feature value after update is applied to the transfer source model evaluation unit 150 as the extended observation data. As a method of applying the feature value after update, for example, when the feature value given by a user is the mean of a temperature sensor, the value of the feature value before extension is 10, and the value of the feature value after extension is 20, 10 may be added to all values of the observation data of the temperature sensor.

Next, a specific example of the transfer destination data extension process will be described. As a specific example, a threshold for the variable epoch is set to 100. In step S300, the data extension unit 140 receives the TIDs of the transfer source and the transfer destination from the transfer source data selecting unit 130. Here, a case in which 1 is received as the TID of the transfer source and 5 is received as the TID of the transfer destination will be described as an example.

After that, the data extension unit 140 acquires the static feature record of the TID of 1. As a result, the static feature record of which the part A width, the part B width, and the raw material X quantity are “0.8”, “10”, and “15”, respectively, is acquired, for example.

The data extension unit 140 acquires the observation data of the TID of 5. As a result, a record group related to the collection time, the TID, the defect determination, and the like in the observation data table 220 illustrated in FIG. 4 is acquired.

The data extension unit 140 acquires information on the static feature model from the static feature model storage unit 24. As a result, “part A width” and “raw material X” which are the static feature factors constituting the static feature model, the feature value names “x₁” and “x₂” for predicting the “part A width”, and the weights “0.15” and “0.01” of these feature values are acquired. Moreover, the feature value generation file 270 that describes the calculation formulas of the feature values “x₁” and “x₂” of the static feature model is acquired.

In step S301, the data extension unit 140 calculates the feature value and substitutes 1 into the variable epoch. As for a feature value calculation method, specifically, records related to the observation data identical to an observation data name described in the input 276 of the feature value generation file 270 acquired in step S300 are acquired from the observation data of the transfer destination, and the records related to the observation data name are applied to the equation described in the logic 277 to calculate the feature value used for the transfer source model. For example, in the case of a method of calculating the feature value of which feature_name 275 is “x₁”, the records related to “temperature A” and “air volume A” are acquired from the observation data of the transfer destination according to “‘temperature A’, ‘air volume A’” described in the input 276, and a value obtained by adding 1.5 times the mean of the observation data related to “air volume A” to the mean of the observation data related to “temperature A” is calculated according to the logic described in the logic 277 (that is, “Mean(‘temperature A’)+1.5*(‘air volume A’)”). The feature value x₂ is calculated by similar procedures to those of the feature value x₁.

Subsequently, in step S302, the data extension unit 140 substitutes the feature value calculated in step S301 into the static feature model to calculate the predicted value of the static feature factor. As a result, with respect to “part A width” and “raw material X” which are the static feature factors included in the static feature model, 0.15*21.0+0.01*12.54=3.275, for example, is calculated as the predicted value of “part A width”, and 0.02 21.0+0.7*12.54=9.198, for example, is calculated as the predicted value of “raw material X”.

In step S303, the data extension unit 140 updates the feature value on the basis of Equations (6) and (7). In Equation (7), since the vector y(x) is (3.275, 9.198), the vector y_{tr_src} is (0.8, 15.0), the vector f(x) is calculated as (2.475, −5.802). Moreover, a 2×2 matrix of which the matrix components a_{i,j} are a_{1,1}=−1.272, a_{1,2}=0.182, a_{2,1}=0.036, and a_{2,2}=−0.273 is calculated as an inverse matrix of the Jacobean matrix H in Equation (6). When Equation (6) is calculated using the above results, 25.204 and 10.867 are calculated as the updated values of the feature values x₁ and x₂, respectively.

In step S304, the data extension unit 140 compares 1 which is the value of the variable epoch and 100 which is a threshold, and since the value of the epoch is equal to or smaller than the threshold, the flow proceeds to step S305.

In step S305, the data extension unit 140 increments the variable epoch to 2 and executes step S302.

The data extension unit 140 repeats steps S302 to S305 until the value of the variable epoch reaches 100 which is the threshold. When step S304 is executed in a state in which the value of the variable epoch is 101, the flow proceeds to step S306.

In step S306, the data extension unit 140 outputs the feature value. In this way, the data extension unit 140 outputs a feature value vector (x₁, x₂) in which the feature value x₁ is 3.9 and the feature value x₂ is 21.14, for example.

According to the transfer destination data expansion process, the analysis model transferability determination apparatus 1 can convert the observation data related to the transfer destination task appropriately to data that is likely to be suitable for an analysis model related to the transfer source. In this way, it is possible to apply transfer training even when the feature of the observation data of the transfer source is not similar to the feature of the observation data of the transfer destination.

Next, the performance evaluation process corresponding to step S14 of FIG. 10 will be described in detail.

FIG. 14 is a flowchart illustrating an example of the performance evaluation process according to the embodiment.

The transfer source model evaluation unit 150 receives the extended observation data from the data extension unit 140 and then acquires the analysis model of the transfer source from the analysis model storage unit 23 on the basis of the TID related to the transfer source task (step S400).

The transfer source model evaluation unit 150 calculates the generalization error by inputting the analysis model (also referred to as a transfer source model) of the transfer source, the extended observation data, and the defect determination result corresponding to the observation data of the transfer destination to f, x, and y of Equation (3), respectively (step S401).

The transfer source model evaluation unit 150 calculates a post-transfer performance improvement rate by dividing the generalization error of the observation data related to the transfer destination with respect to the transfer source model by the generalization error of the extended observation data with respect to the transfer source model and calculates the transferability by dividing the generalization error of the observation data related to the transfer source with respect to the transfer source model by the generalization error of the extended observation data with respect to the transfer source model (step S402).

Next, a specific example of the performance evaluation process will be described.

In step S400, the transfer source model evaluation unit 150 receives the extended observation data and acquires the transfer source model. As a result, extended observation data of which x₁ is 0.03 and x₂ is 1.54, for example, is received. Moreover, the record of which the TID in the analysis model table 230 in FIG. 5 is 1 is acquired. That is, a record of which the base model name is “k-NN”, the model parameter list is “k:1, metric: ‘minkowski’”, and the feature value generation file path is “product_x/type_a.json” is acquired.

Subsequently, in step S401, the transfer source model evaluation unit 150 calculates the generalization error by inputting the record related to the transfer source model acquired in step S400, the extended observation data, and the measured value of the defect determination corresponding to the observation data of the transfer destination into Equation (3).

Specifically, first, the transfer source model evaluation unit 150 obtain prediction results related to n types of defect determination by inputting parameter values described in the model parameter list to a statistic and machine learning method described in the base model name included in the record related to the transfer source model and then inputting the calculated n pieces of extended observation data. For example, the transfer source model evaluation unit 150 inputs 1 to k which is a parameter of a k-nearest neighbor method (k-nearest neighbor: k-NN) described in the base model name and selects “minkowski” as metric. Subsequently, the transfer source model evaluation unit 150 acquires n predicted values such as “0” which is a predicted value meaning a non-defective product by inputting n types of extended observation data one by one according to the k-nearest neighbor method. After that, the transfer source model evaluation unit 150 calculates the generalization error by inputting a measured value of the determination result related to the predicted value and the extended observation data to Equation (3). For example, when the three predicted values are “0”, “1”, and “0” and the measured values related to the extended observation data are “0”, “0”, and “0”, ((0−0)²+(1−0)²+(0−0)²)/3=0.33 is obtained as the generalization error.

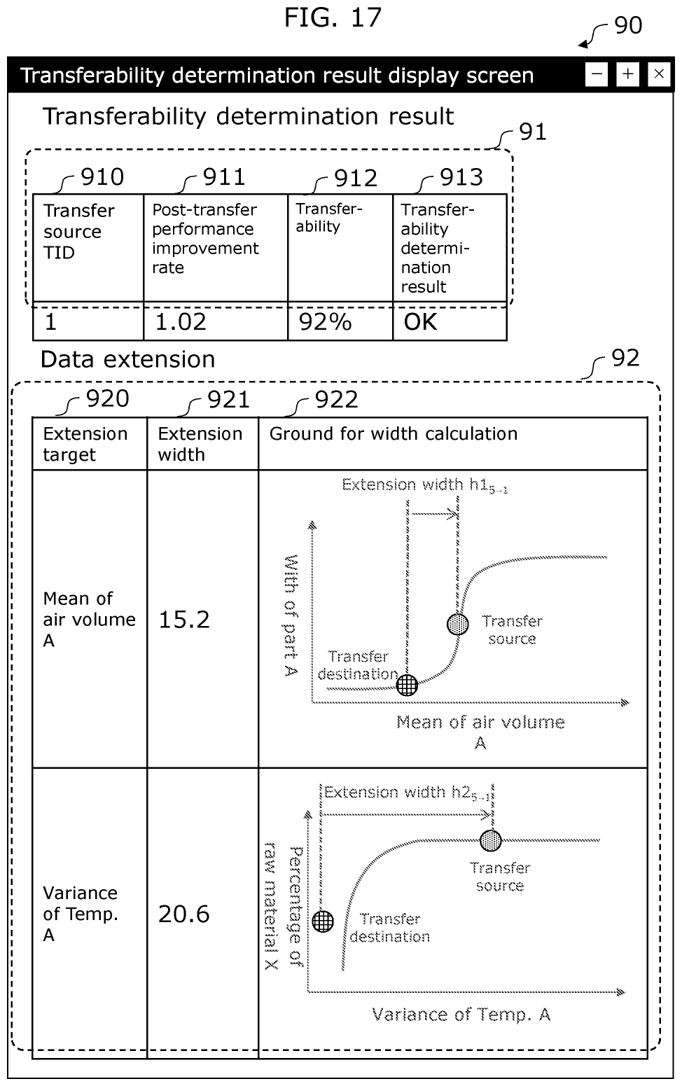

Subsequently, in step S402, the transfer source model evaluation unit 150 calculates the post-transfer performance improvement rate and the transferability. The post-transfer performance improvement rate is calculated as 0.33/0.322=1.02 when the generalization error of the extended observation data with respect to the transfer source model and the generalization error of the observation data related to the transfer destination with respect to the transfer source model are calculated as 0.33 and 0.322 in step S401. The transferability (evaluation result) is calculated as 0.305/0.33 100=92% when the generalization error of the observation data related to the transfer source with respect to the transfer source model is 0.305, for example. In step S15 of FIG. 10 performed subsequently, when the threshold of the transferability is 90%, since the transferability of 92% is equal to or larger than the threshold of 90%, the transferability is determined to be equal to or larger than the threshold and a transferability flag (“OK”) is set. The post-transfer performance improvement rate and the transferability calculated in step S402 and the transferability flag (transferability determination result) in step S15 are displayed on a transferability determination result screen 90 (see FIG. 17) to be described later by the transfer source model evaluation unit 150, for example.

According to the performance evaluation process, the analysis model transferability determination apparatus 1 can determine whether the transfer source model can be transferred to the task of the transfer destination easily and appropriately.

Next, various screens displayed by the analysis model transferability determination apparatus 1 will be described.

FIG. 15 is a diagram illustrating an example of the data input screen.

The data input screen 70 is a screen displayed on the user I/F 50 by the data input unit 110 so as to input the static feature data and the observation data. The data input screen 70 includes a static feature data input field 700, an observation data input field 701, a transferability determination button 702, and a transition button to analysis model information input screen 703.

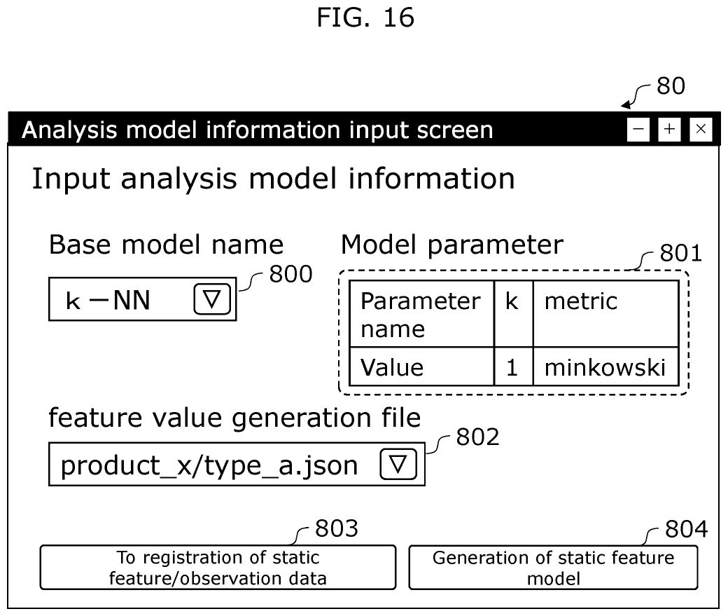

The static feature data input field 700 is a field for inputting static feature data. The input of a pair of a static feature factor and the value thereof is received in the static feature data input field 700. The observation data input field 701 is a field for designating (inputting) a file or a directory in which observation data is stored. The transferability determination button 702 is a button for activating a process (the main process) of selecting an analysis model that can be transferred to a task related to the data described in the static feature data input field 700 and the observation data input field 701 and calculating the transferability of the analysis model. When the transferability determination button 702 is pressed, the main process is executed. The transition button to analysis model information input screen 703 is a button for activating a process of transiting the screen to an analysis model information input screen 80 (see FIG. 16). When the switch button to analysis model information input screen 703 is pressed, the data input unit 110 displays the analysis model information input screen 80.

For example, in the static feature data input field 700 of the data input screen 70 illustrated in FIG. 15, the values of static feature factors of “0.8”, “10”, “15%”, “3%”, and the like are input in the input fields related to the four static feature factors including “part A width”, “part B width”, “raw material X proportion”, and “raw material Y proportion”. Moreover, “product_x/sensor_data” which is a directory name in which the observation data is stored is input in the observation data input field 701.

Next, the analysis model information input screen 80 will be described.

FIG. 16 is a diagram illustrating an example of an analysis model information input screen.

The analysis model information input screen 80 is a screen for inputting information on an analysis model. The analysis model information input screen 80 includes a base model name input field 800, a model parameter input field 801, a feature value generation file input field 802, a transition button to data input screen 803, and a static feature model generation button 804. The base model name input field 800 is a field for inputting the name of a method used for generating an analysis model. The model parameter input field 801 is a field for inputting a parameter name related to the method corresponding to the method name input in the base model name input field 800 and the value of the parameter. The feature value generation file input field 802 is a field for inputting a path to the feature value generation file 270. The transition button to data input screen 803 is a button for activating a process of transiting the screen to the data input screen 70. When the transition button to data input screen 803 is pressed, the data input unit 110 displays the data input screen 70. The static feature model generation button 804 is a button for activating a process of generating a static feature model.

For example, in the analysis model information input screen 80 illustrated in FIG. 16, “k-NN” is input in the base model name input field 800. Moreover, “k” indicating a parameter name and “1” indicating the value of the parameter are input in the model parameter input field 801. “product_x/type_a.json” which is a path to the feature value generation file 270 is input to the feature value generation file input field 802.

Next, the transferability determination result screen will be described.

FIG. 17 is a diagram illustrating an example of a transferability determination result screen.

The transferability determination result screen 90 is a screen for outputting information related to the determination result of transferability. The determination result display screen 90 includes a transferability determination result display field 91 and a data extension result display field 92. The transferability determination result display field 91 is a field for displaying a determination result related to transferability. The transferability determination result display field 91 includes a transfer source TID display field 910, a post-transfer performance improvement rate display field 911, a transferability display field 912, and a transferability determination result display field 913. The transfer source TID display field 910 is a field for displaying a TID related to a transfer source task. The post-transfer performance improvement rate display field 911 is a field indicating the proportion of performance improvement before and after extension of observation data, and for example, the post-transfer performance improvement rate 262 is displayed. The transferability display field 912 is a field for displaying the transferability of a transfer source model to a transfer destination task, and for example, the transferability 263 is displayed. The transferability determination result display field 913 is a field for displaying a determination result on whether the transfer source model can be transferred to the transfer destination task, and the transferability determination result 264 is displayed.

The data extension result display field 92 is a field indicating a method of extending the feature value to extended observation data. The data extension result display field 92 includes an extension target display field 920, an extension width display field 921, and a width calculation ground display field 922. The extension target display field 920 is a field for displaying the name of an extension target feature value. The extension width display field 921 is a field for displaying an extension width of an extension target feature value. The width calculation ground display field 922 is a field indicating the ground for calculating the extension width displayed in the extension width display field 921, and a graph of a static feature model is displayed in which a horizontal axis indicates an expansion target feature value (an explanatory function) and a vertical axis indicates a static feature factor (an objective function). On this graph, data (the second observation data) related to the transfer destination task and data (extended observation data: corresponding to a transfer source in the drawing) of the transfer destination task are plotted. The type of a static feature factor on the vertical axis may be selected by a user.

For example, in the transferability determination result display field 91 of the transferability determination result display screen 90 illustrated in FIG. 17, an entry in which the transfer source TID display field 910 is “1”, the post-transfer performance improvement rate display field 911 is “1.02”, the transferability display field 912 is “92%”, and the transferability determination result display field 913 is “OK” is displayed. Moreover, in the data extension result display field 92, a plurality of entries including an entry in which the extension target display field 920 is “mean of air volume A”, the extension width display field 921 is “15.2”, an S-shaped function graph is displayed in the width calculation ground display field 922 is displayed.

According to the transferability determination result display screen 90, a user can understand the post-transfer performance improvement rate of the transfer source task with respect to the analysis model, the transferability, and the determination result of the transferability appropriately by referring to the transferability determination result display field 91. Moreover, the user can understand the extension target feature value, the extension width, and the extension width calculation ground appropriately by referring to the data extension result display field 92.

The present invention is not limited to the above-described embodiment but can be changed appropriately without departing from the spirit of the present invention.

For example, in the above-described embodiment, a designation of a transfer source model to be used in a transfer destination task among transfer source models of which the post-transfer performance improvement rate, the transferability, and the transferability determination result are displayed may be received from a user and defect determination in the transfer destination task may be performed using the designated transfer source model. Specifically, the processor 30 may receive a designation of an analysis model of a transfer source task to be transferred to a prescribed transfer destination task from a user, receive new observation data related to the transfer destination task, generate extended observation data corresponding to an analysis model of the transfer source task from the observation data, input the extended observation data to the analysis model of the transfer source task, and perform defect determination in the transfer destination task. In this case, the processor 30 corresponds to a designation receiving unit and a defect determination unit. By doing so, it is possible to perform defect determination in the transfer destination task easily and appropriately using the designated transfer source model.

In the embodiment, some or all of the steps of processing performed by the processor may be performed by a hardware circuit. A program in the embodiment may be installed from a program source. The program source may be a program distribution server or a storage medium (for example, a portable storage medium).

What is claimed is:

1. A transferability determination apparatus that determines transferability of an analysis model of a transfer source task to a transfer destination task, comprising:
a data input unit configured to receive the input of first static feature data indicating static features related to a target object and/or an event of the transfer source task and first observation data obtained by observing an object and/or an event that affects the target object and/or the event of the transfer source task;
a static feature information modeling unit configured to generate a static feature model using the first static feature data as an objective variable and the feature value related to the first observation data as an explanatory variable;
a transfer source data selecting unit configured to receive second static feature data indicating static features related to a target object and/or an event of the transfer destination task and select first static feature data to be used for processing among a plurality of pieces of first static feature data on the basis of a distance between the first static feature data and the second static feature data;
a data extension unit configured to receive second observation data obtained by observing an object and/or an event that affects the target object and/or the event of the transfer destination task and calculate extended observation data appropriate for use in the analysis model on the basis of the second observation data, the selected first static feature data, and the static feature model; and
a transfer source model evaluation unit configured to calculate a generalization error of a prediction result obtained by inputting the extended observation data to the analysis model and evaluate transferability of the analysis model to the transfer destination task on the basis of the generalization error.

2. The transferability determination apparatus according to claim 1, wherein
the transfer source model evaluation unit displays information on the transferability.

3. The transferability determination apparatus according to claim 1, wherein
the static feature information modeling unit is configured to:
perform a process of determining a feature value to be used among a plurality of types of feature values to generate a static feature model and calculating a generalization error of the static feature data for the generated static feature model a plurality of times while changing a combination of feature values to be used; and
determine a static feature model in which the generalization error of the static feature data is the smallest among a plurality of static feature models or is equal to or smaller than a prescribed threshold as the static feature model to be used.

4. The transferability determination apparatus according to claim 1, wherein
the static feature information modeling unit is configured to calculate the generalization error of each of the static feature factors of the static feature data output by the generated static feature model and determine a static feature model in which only the static feature factor of which the generalization error is equal to or smaller than a prescribed threshold is used as an objective variable as the static feature model to be used.

5. The transferability determination apparatus according to claim 1, wherein
the data extension unit is configured to calculate a solution of an explanatory variable of the static feature model by an iterative method so that a feature value based on the second observation data related to the transfer destination task is an initial value of the explanatory variable of the static feature model and a difference between the value of the selected first static feature data related to the transfer source task and an output value of the static feature model is reduced and output the solution of the explanatory variable as the extended observation data.

6. The transferability determination apparatus according to claim 1, wherein
the transfer source model evaluation unit is configured to display a graph representing a relationship between the objective variable and the explanatory variable of the static feature model and display the second observation data and the extended observation data so as to correspond to the graph.

7. The transferability determination apparatus according to claim 1, further comprising:
a designation receiving unit configured to receive a designation of an analysis model of the transfer source task to be transferred to the transfer destination task, wherein
the data input unit is configured to receive third observation data obtained by newly observing an object and/or an event that affects the target object and/or the event of the transfer destination task,
the data expansion unit is configured to calculate extended observation data appropriate for use in the designated analysis model on the basis of the third observation data, the transferability determination apparatus further comprising:
a defect determination unit configured to perform defect determination in the transfer destination task by inputting the extended observation data to the designated analysis model.

8. A transferability determination method performed by a transferability determination apparatus that determines transferability of an analysis model of a transfer source task to a transfer destination task, the method comprising:
receiving the input of first static feature data indicating static features related to a target object and/or an event of the transfer source task and first observation data obtained by observing an object and/or an event that affects the target object and/or the event of the transfer source task;
generating a static feature model using the first static feature data as an objective variable and the feature value related to the first observation data as an explanatory variable;
receiving second static feature data indicating static features related to a target object and/or an event of the transfer destination task and selecting first static feature data to be used for processing among a plurality of pieces of first static feature data on the basis of a distance between the first static feature data and the second static feature data;
receiving second observation data obtained by observing an object and/or an event that affects the target object and/or the event of the transfer destination task and calculating extended observation data appropriate for use in the analysis model on the basis of the second observation data, the selected first static feature data, and the static feature model; and
calculating a generalization error of a prediction result obtained by inputting the extended observation data to the analysis model and evaluating transferability of the analysis model to the transfer destination task on the basis of the generalization error.

9. A non-transitory computer readable medium having a transferability determination program recorded therein, for causing a computer to execute a process of determining transferability of an analysis model of a transfer source task to a transfer destination task, the transferability determination program causing the computer to function as:
a data input unit configured to receive the input of first static feature data indicating static features related to a target object and/or an event of the transfer source task and first observation data obtained by observing an object and/or an event that affects the target object and/or the event of the transfer source task;
a static feature information modeling unit configured to generate a static feature model using the first static feature data as an objective variable and the feature value related to the first observation data as an explanatory variable;
a transfer source data selecting unit configured to receive second static feature data indicating static features related to a target object and/or an event of the transfer destination task and select first static feature data to be used for processing among a plurality of pieces of first static feature data on the basis of a distance between the first static feature data and the second static feature data;
a data extension unit configured to receive second observation data obtained by observing an object and/or an event that affects the target object and/or the event of the transfer destination task and calculate extended observation data appropriate for use in the analysis model on the basis of the second observation data, the selected first static feature data, and the static feature model; and
a transfer source model evaluation unit configured to calculate a generalization error of a prediction result obtained by inputting the extended observation data to the analysis model and evaluate transferability of the analysis model to the transfer destination task on the basis of the generalization error.
